(19) United States
(12) Patent Application Publication
(10) Pub. No.: US 2025/0382181 A1
(43) Pub. Date: Dec. 18, 2025

(54) ACCRETION OF CARBON NANOTUBES

(71) Applicant: Chevron U.S.A. Inc., San Ramon, CA (US)

(72) Inventors: Xiaoying OUYANG, Albany, CA (US); Huping LUO, Moraga, CA (US); Howard Steven LACHEEN, Richmond, CA (US)

(73) Assignee: Chevron U.S.A. Inc., San Ramon, CA (US)

(21) Appl. No.: 19/239,236

(22) Filed: Jun. 16, 2025

Related U.S. Application Data
(60) Provisional application No. 63/661,093, filed on Jun. 18, 2024.

(51) Int. Cl. C01B 32/162; B01J 21/18; B01J 23/755; B01J 35/45; B01J 37/08; C01B 32/166; C01B 32/17

(52) U.S. Cl. CPC C01B 32/162; B01J 21/185; B01J 23/755; B01J 35/45; B01J 37/088; C01B 32/166; C01B 32/17; C01B 2202/36; C01P 2004/13

(57) ABSTRACT

A method of producing carbon nanotubes is provided in which a Ni—Cu alloy catalyst on a carbon nanotube support is exposed to a light hydrocarbon stream at a temperature ranging from 500-700° C. After exposure, a carbon nanotube product is recovered comprising support carbon nanotubes and accreted nanotubes. The exposure also produces hydrogen.

### CROSS REFERENCE TO RELATED APPLICATIONS

The present application claims priority to U.S. Provisional Application No. 63/661,093, filed Jun. 18, 2024, the complete disclosure of which is incorporated herein by reference in its entirety.

### FIELD OF THE INVENTION

Preparing carbon nanotubes. More specifically, preparing carbon nanotubes under a catalytic environment.

### BACKGROUND

Carbon nanotubes have many promising applications due to their high thermal conductivity, high electrical conductivity, unique aspect ratio, very elastic ˜18% elongation at break, very high tensile strength, high flexibility, and low coefficient of thermal expansion. One of the widely used methods to produce carbon nanotubes is by substrate-based chemical vapor deposition (CVD) or floating catalyst chemical vapor deposition (FCCVD), both of which combine a metal catalyst with carbon-containing reaction gases, and as a result, the carbon nanotubes are formed on the catalyst in a furnace. Other methods include arc discharge, laser ablation and plasma torch, which are more energy intensive and difficult to scale up. Despite all the interesting properties, widespread use of carbon nanotubes in practice is still a long way off. One of the biggest hurdles is the high cost of production. A faster, more scalable and more efficient manufacturing method is needed.

### SUMMARY

A method of producing carbon nanotubes is provided in which a Ni—Cu alloy catalyst on a carbon nanotube support is exposed to a light hydrocarbon stream at a temperature ranging from 500-700° C. After exposure, a carbon nanotube product is recovered comprising support carbon nanotubes and accreted carbon nanotubes. Hydrogen is also recovered as a product.

In one embodiment, the particle size of the Ni—Cu alloy is no larger than 50 nm. In one embodiment the particle size is in the range of from 5-50 nm or in the range of from 20-30 nm. In one embodiment, the temperature of exposure is in the range of from 500-700° C., or in one embodiment in the range of from 550-650° C. In one embodiment, in recovering a carbon nanotubes product, the carbon nanotubes product is acid leached to remove Ni and Cu metal from the solid carbon product.

In another embodiment, a carbon nanotubes product comprising support carbon nanotubes and accreted carbon nanotubes is recovered.

Among other factors, provided is an efficient manufacturing method of carbon nanotubes. The production of the carbon nanotubes by the present process can also provide blue hydrogen and a solid carbon product which comprises carbon nanotubes. The manufactured carbon nanotubes are prepared under a catalytic environment that also results in added, beneficial products such as hydrogen. Under the catalytic environment, the carbon nanotubes are formed by accretion. The recovered solid carbon product can comprise the accreted carbon nanotubes and original support carbon nanotubes.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 and FIG. 2 schematically show how the accreted carbon nanotubes are formed.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

Before the (accreted) carbon nanotubes, and collection of the product, processes for making are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

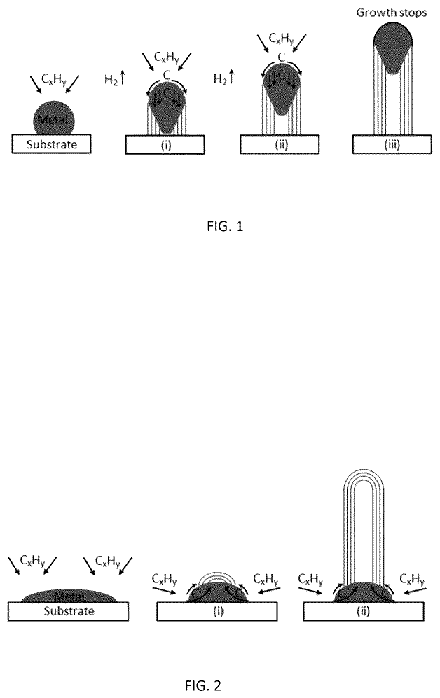

The present invention relates to a method of using existing carbon nanotubes to accrete more carbon nanotubes under a catalytic environment while co-producing low carbon intensity hydrogen. The existing carbon nanotubes are used as a catalyst support to impregnate a Ni—Cu alloy catalyst, and this catalytic material can be referred to as Ni—Cu/CNT. To accrete more carbon nanotubes, the Ni—Cu/CNT material is exposed to a flowing light hydrocarbon stream at a temperature in the range of 500-700° C. The hydrocarbon molecule is dissociatively adsorbed on the Ni surface to produce hydrogen and carbon. A chemical potential of carbon is then formed throughout the bulk of the Ni—Cu alloy particle and the carbon can diffuse through the bulk to nucleate and incorporate into a carbon nanotube structure. Notably, whether a carbon nanotube structure can be formed depend on the particle size of the Ni—Cu alloy. The schemes shown in FIGS. 1 and 2 depict how the carbon nanotubes are formed. The substrate comprises carbon nanotubes.

FIG. 1 shows the most common scheme as to how the carbon nanotubes are formed. In FIG. 1, the metal alloy is on the substrate as carbon diffuses to the metal alloy particles to nucleate and create a carbon nanotube structure. As the structure is created, the Ni—Cu alloy particle is actually pushed up and away from the substrate, which substrate comprises carbon nanotubes.

In FIG. 2, a less common scheme for creating the carbon nanotubes is shown. In this scheme the Ni—Cu alloy particle remains on the substrate as the carbon nanotubes grow. While both schemes generally occur, the scheme shown in FIG. 2 is believed to occur less frequently.

The yield of the accreted carbon nanotubes is affected by a number of things, with three being most important. First, the Ni—Cu needs to have a high degree of alloying and the ratio of Ni to Cu needs to be from 1/1 to 100/1 Ni/Cu. In one embodiment, the molar ratio of Ni/Cu can range from 1/1 to 30/1, and in another embodiment from 1/1 to 10/1. Second, the particle sizes of the Ni-Cu alloy particles need to be under 50 nm, otherwise a “nano-onion” structure is formed which deactivates the catalyst. Preferably the particle size is in the range of 5-50 nm, more preferably in the range of 20-30 nm. Third, the reaction temperature needs to be in the range of 500 to 700° C., and in one embodiment from 550 to 650° C.

The present incipient wetness impregnation method follows a protocol involving mixing a chelating agent with a nickel precursor solution and a copper precursor solution either simultaneously or sequentially to prepare a mixture. The nickel precursor solution can be, but is not limited to a nickel salt such as nickel nitrate, nickel sulfate, nickel acetate, nickel acetylacetonate, nickel chloride in an aqueous or organic solvent. The copper solution can be, but is not limited to a copper salt such as copper nitrate, copper sulfate, copper acetate, copper acetylacetonate, copper chloride in an aqueous or organic solvent. The selection of the particular organic solvent is dependent on the solubility of the Ni salt and Cu salt. Common organic solvents that may be used in this preparation are, but not limited to, acetone, toluene, THE, and ethanol. Other suitable organic solvents are well known to one in the industry. Aqueous solutions can also be used.

A chelating agent can be added to the impregnation solution comprising Ni and Cu to improve the uniformity of the metal dispersion on the support, and therefore increase the degree of alloying to improve the catalyst stability and the yield of the accreted carbon nanotubes.

A characteristic of solutions containing chelating agents is that the viscosity of metal complex solutions increases significantly due to a gelling process, affecting the drying stage, inhibiting the redistribution of surface species and favoring the formation of poorly crystalized compounds with high dispersion. It has now been discovered that by adding a chelating agent to the impregnation solution at an optimum ratio of Ni and Cu one can improve the uniformity of the metal dispersion on the support, and therefore increase the degree of alloying to improve the catalyst stability and the yield of the accreted carbon nanotubes obtained.

The term “chelating agent,” as used herein, may be used interchangeably with “ligand”, “ligating agent” or “complexing agent” (or chelator, or chelant), referring to an additive that combines with metal ions, e.g., Group VIB and/or Promoter metals, forming a larger complex, e.g., a catalyst precursor, and facilitating the tuning or adjustment of the porosity of the mesopores.

In one embodiment, the chelating agent is charge neutral or has a negative charge. In another embodiment, the chelating agent is a non-toxic organic oxygen containing compound with an LD50 rate (as single oral dose to rats) of greater than 500 mg/kg. The term “charge neutral” refers to the fact that the catalyst precursor carries no net positive or negative charge. Examples include but are not limited to polydentate as well as monodentate, e.g., NH₃ as well as alkyl and aryl amines; carboxylates, carboxylic acids, aldehydes, ketones, the enolate forms of aldehydes, the enolate forms of ketones and hemiacetals; organic acid addition salts such as formic acid, acetic acid, propionic acid, maleic acid, malic acid, gluconic acid, fumaric acid, succinic acid, tartaric acid, citric acid, oxalic acid, glyoxylic acid, aspartic acid, alkane sulfonic acids, aryl sulfonic acids; arylcarboxylic acids; carboxylate containing compounds; and combinations thereof.

In one embodiment, the chelating agent used in the present method of producing Ni—Cu alloy catalysts can comprise malic acid, citric acid, oxalic acid, EDTA (ethylene diamine tetraacetic acid) and HEDP (etidroniuc acid or 1-hydroxyethylidene diphosphonic acid). In another embodiment, the chelating agent is citric acid.

As discussed previously, the molar ratios of the Ni and Cu are important. As well, when a chelating agent is present, the molar ratios of the Ni, Cu, and chelating agent are important. The impregnation solution should have sufficient copper precursor, nickel precursor and chelating agents to ensure a successful metal dispersion on the support. The molar ratio of Ni to Cu in the impregnation solution can range from 1/1 to 100/1 nickel/copper. In one embodiment, the molar ratio of nickel/copper can range from 1/1 to 30/1, and in another embodiment from 1/1 to 10/1. The molar ratio of nickel/chelating agent in the impregnation solution can range from 5/1 to 1/50 nickel/chelating agent. In another embodiment, the molar ratio of nickel/chelating agent can range from 2/1 to 1/20, and in another embodiment, from 1/1 to 1/10.

The range of the Ni—Cu alloy particle can vary greatly. Generally, the diameter of the particle is 50 nm or less. In one embodiment, the diameter of the alloy particle can range from 5 to 50 nm, and in another embodiment from 20 to 30 nm.

Once the mixture has been made, the mixture is brought in contact with the carbon nanotube support to impregnate the support with the mixture. The support can be placed in solution with the mixture and stirred to affect impregnation. Sonication can be used to aid in affecting the impregnation of the support, but sonication is optional. Should sonication be used, it would generally precede stirring of the solution to affect impregnation. The mixture could also be sprayed onto the support to impregnate the support. Simply soaking the support in the mixture can also be effective. Any suitable impregnation method can be used.

The support must comprise carbon nanotubes in the present process. Such carbon nanotubes are commercially available, for example, and can be purchased from Cheaptubes.com. The carbon nanotubes can generally have an outside diameter (O.D.) that ranges from 5 to 150 nm. In one embodiment, the O.D. can range from 10-100 nm, or even from 20-50 nm, or 20-30 nm.

The impregnated carbon nanotubes are then dried, i.e., any solvent, organic or aqueous, is removed. The drying can be at a suitable temperature and for a length of time needed to ensure the solids are dry and free of solvent. The drying can also take place in stages, or in a single stage of drying. When an organic solvent is used, the drying can take place by allowing the solvent to evaporate at ambient conditions. Additional drying can take place at a temperature of about 100-150° C., in one embodiment around 140° C., for a length of time ranging from 5-9 hours, in one embodiment about 8 hours. Such additional drying is often employed should the copper or nickel precursors have coordinated water.

Further heating of the impregnated carbon nanotubes to decompose any remaining metal salts can then be conducted. The decomposition leaves nickel and copper oxides on the support. The heating can take place immediately after drying or shortly before use of the catalyst in a methane decomposition reaction, or both. The heating for decomposing any remaining metal salts can generally be accomplished at a temperature that ranges from 150-400° C. In one embodiment, the temperature ranges from 200-300° C. The length and temperature used will depend on the quantity of the metal salts.

Before the Ni—Cu alloy catalyst comprising the carbon nanotube support is exposed to the light hydrocarbon stream, it is generally reduced/activated by heating at a high temperature in the range of 400 to 700° C. In one embodiment, the temperature is about 600° C. The activation can be conducted in the presence of hydrogen, but this is optional. If hydrogen is used, it can be diluted with an inert gas such as nitrogen. The level of hydrogen, if used, can range from 1 vol. % to 100 vol. %, but is generally in the 5 to 10 vol. % range with the remainder nitrogen or another inert gas.

The exposure to the light hydrocarbon stream is at a temperature in the range of from 500 to 700° C. In one embodiment the temperature is in the range of from 550 to 650° C. The hydrocarbon molecule is dissociately adsorbed on the Ni—Cu alloy particle surface to produce hydrogen and carbon. A chemical potential of carbon is believed formed through the bulk of the Ni—Cu alloy particle and the carbon can diffuse through the bulk to nucleate and incorporate into a carbon nanotube structure. FIGS. 1 and 2 schematically depict the apparent processes involved.

The hydrocarbons that can be used in the exposure can comprise any suitable 1-6 C hydrocarbon. The hydrocarbon can comprise an alkane, an alkene or alkyne. In one embodiment, an alkane is used. In one embodiment, the hydrocarbon comprises a 1-3 C hydrocarbon. The 1-3 C hydrocarbon in one embodiment comprises an alkane. Methane, ethane, and propane can be used, with methane preferred.

The process of exposure can take place in a fluidized bed reactor.

In the process, the low carbon hydrogen leaves the reactor and is continuously collected to recover its economic value. The activity of the Ni—Cu alloy gradually decreases over time, at which point it becomes profitable to remove the reacting material from the fluidized bed reactor to recover the solid product. The solid product comprises the accreted carbon nanotubes (majority), the original carbon nanotubes as a support (minority), and the Ni—Cu alloy. An acid leaching method can be applied in one embodiment to remove Ni and Cu metals. The acids that can be used in the leaching process are well known and can include nitric acid, sulfuric acid, and hydrochloric acid. After drying, the resulting solid carbon material is a carbon nanotube product.

In one embodiment, a portion of the carbon nanotube product, especially after leaching, can be re-used as support in another process. Part of the carbon nanotube product can be used. The selected portion of the carbon nanotubes can be impregnated and used again in another carbon nanotube accretion process. Beneficially this can happen in the same facility.

The following examples are provided to further exemplify the present process of preparing carbon nanotubes. The examples are not meant to be limiting.

Example 1: The catalyst is prepared by mixing a 400 mL acetone solution containing Ni(NiO₃)₂·6H₂O (7.71 g) and Cu(NO₃)₂·2.5H₂O (0.521 g) with 13 g of multiwalled carbon nanotubes (20-30 nm, purchased from Cheaptubes.com). The mixture was sonicated for 30 min and stirred for 2 h at room temperature. Then, the solvent was allowed to evaporate at ambient conditions in a fume hood. Once dry, the solids were heat treated: first dried at 140° C. for 8 h and then to 250° C. for 8 h in flowing N2. This catalyst is denoted as Sample #1.

Example 2: The catalyst is prepared by mixing a 400 mL acetone solution containing Ni(NiO₃)₂·6H₂O (7.71 g) and Cu(NO₃)₂·2.5H₂O (0.521 g) with 13 g of activated carbon powder (DARCO® G-60). The mixture was sonicated for 30 min and stirred for 2 h at room temperature. Then, the solvent was allowed to evaporate at ambient conditions in a fume hood. Once dry, the solids were heat treated: first dried at 140° C. for 8 h and then to 250° C. for 8 h in flowing N2. This catalyst is denoted as Sample #2.

Example 3: The catalyst is prepared by mixing a 400 mL acetone solution containing Ni(NiO₃)₂·6H₂O (7.71 g) and Cu(NO₃)₂·2.5H₂O (0.521 g) with 13 g of Al₂O₃(PURALOX® SCCa-150-230). The mixture was sonicated for 30 min and stirred for 2 h at room temperature. Then, the solvent was allowed to evaporate at ambient conditions in a fume hood. Once dry, the solids were heat treated: first dried at 140° C. for 8 h and then to 250° C. for 8 h in flowing N₂. This catalyst is denoted as Sample #3.

Example 4: The catalyst is prepared by mixing a 400 mL acetone solution containing Ni(NiO₃)₂·6H₂O (7.71 g), Cu(NO₃)₂·2.5H₂O (0.521 g), and citric acid (3.700 g) with 13 g of multiwalled carbon nanotubes (20-30 nm, purchased from Cheaptubes.com). The mixture was sonicated for 30 min and stirred for 2 h at room temperature. Then, the solvent was allowed to evaporate at ambient conditions in a fume hood. Once dry, the solids were heat treated: first dried at 140° C. for 8 h and then to 250° C. for 8 h in flowing N₂. This catalyst is denoted as Sample #4.

Example 5: Catalytic test: a fluidized bed quartz reactor is used for methane catalytic cracking reaction at ambient pressure. The diameter of the reactor is 1″. The reactor is set up in a vertical three-zone heater. As-synthesized catalysts (1.3 g) is loaded on a distributor made from a quartz frit which is in the middle of the reactor so that the fluidized catalyst bed is within the isothermal zone of the heater. N₂ gas is used as an internal standard for product analysis using online GC. Prior to each test, the 1.3 g catalyst samples are reduced in situ at 600° C. under 25 mL/min 5 vol % H₂/Ar overnight. Subsequently, the feed is switched to 52 mL/min 32 vol % CH₄/N₂. The methane conversion is calculated based on the disappearance of methane from the feed.

Example 6: Acid Leaching: The solid product from the catalytic test using Sample #4 is recovered. The powder (1 g) is added to a 1 mol/L nitric acid solution (100 mL) and heated to 70° C. for 4 hours with stirring. The material is then recovered by filtration, washing with DI water (3×100 mL) and drying at 120° C. for 4 hours to remove the solvent. The final product contains less than 10 ppm of Ni or Cu.

Example 7: The table below compares sample #1-#4 for the yields of carbon nanotubes formed. The results show that only when the catalyst support is carbon nanotubes (sample #1 and #4), satisfactory yields are obtained. The activated carbon and Al₂O₃ give very low yields and are not suitable for commercialization. (Accreted carbon nanotubes yield=weight of accreted carbon nanotubes/(weight of accreted carbon nanotubes+weight of catalyst support)×100%).

| Samples | Accreted carbon nanotubes yield |
|---|---|
| #1 | 93% |
| #2 | 5% |
| #3 | 40% |
| #4 | 95% |

As used in this disclosure the word “comprises” or “comprising” is intended as an open-ended transition meaning the inclusion of the named elements, but not necessarily excluding other unnamed elements. The phrase “consists essentially of” or “consisting essentially of’ is intended to mean the exclusion of other elements of any essential significance to the composition. The phrase “consisting of’ or “consists of’ is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise that as specifically described without actually departing from the spirit and scope of the present invention as defined by the appended claims.

What is claimed is:

1. A method of producing carbon nanotubes comprising:
providing a mixture of a nickel precursor salt and a copper precursor salt in solution;
contacting carbon nanotubes with the mixture to impregnate the carbon nanotubes with the mixture;
exposing the impregnated carbon nanotubes with a light hydrocarbon stream at a temperature in the range of 500 to 700° C.; and
collecting carbon nanotubes as a product.

2. The method of claim 1, wherein the solution of the mixture is an organic based solution or an aqueous solution.

3. The method of claim 2, wherein the solution comprises an organic solvent.

4. The method of claim 3, wherein the organic solvent comprises acetone.

5. The method of claim 1, wherein the contacting of the support with the mixture to impregnate the support with the mixture comprises spraying the support with the mixture, stirring a solution comprising the support and the mixture, or sonicating a solution comprising the support and the mixture.

6. The method of claim 1, wherein solvent is removed from the impregnated support to produce a Ni—Cu alloy solid catalyst comprising carbon nanotubes as the support.

7. The method of claim 6, wherein the solid catalyst is heated to remove coordinated water from the copper and nickel precursors.

8. The method of claim 7, wherein the heating is to a temperature in the range of from 100 to 150° C.

9. The method of claim 7, wherein the heated solid is further heated to a temperature in the range of from 150 to 400° C. for a period of time sufficient to decompose the metal salts and leave copper and nickel metal oxides on the support.

10. The method of claim 1, wherein the mixture of nickel precursor salt and copper precursor salt further comprises a chelating agent.

11. The method of claim 10, wherein the chelating agent is malic acid, citric acid, oxalic acid, EDTA, HEDP, or a mixture thereof.

12. The method of claim 1, wherein the nickel precursor comprises a nickel nitrate and the copper precursor comprises a copper nitrate compound.

13. The method of claim 1, wherein the carbon nanotubes of the support have an outside diameter that ranges from 5-150 nm.

14. The method of claim 13, wherein the outside diameter ranges from 20-50 nm.

15. The method of claim 1, wherein the impregnated carbon nanotubes are contacted at a temperature in a range of from 500 to 650° C.

16. The method of claim 1, wherein the yield of accreted carbon nanotubes product is at least 90%, or at least 93%, or at least 95%.

17. A carbon nanotubes product comprising support carbon nanotubes and accreted carbon nanotubes.

18. The carbon nanotubes product of claim 17, wherein the accreted carbon nanotubes comprise at least 90 wt. % of the product, or at least 95 wt. % of the product.

19. The carbon nanotubes product of claim 17, wherein the carbon nanotubes have an outside diameter ranging from 5 to 150 nm.

20. The product of claim 19, wherein the outside diameter ranges from 10 to 100 nm, or 20 to 50 nm, or 20 to 30 nm.

21. The method of claim 1, wherein the molar ratio of Ni to Cu in the mixture ranges from 1/1 to 100/1 nickel/copper, or 1/1 to 30/1 nickel/copper, or from 1/1 to 10/1 nickel to copper.

22. The method of claim 21, wherein the diameter of the Ni-Cu alloy particles is no larger than 50 nm, or is in the range of from 5-50 nm, or in the range of from 20-30 nm.

23. The method of claim 21, wherein the temperature of exposure is in the range of from 500-700° C., or in the range of from 550-650° C.

24. The method of claim 1, wherein the carbon nanotubes product is acid leached to removed Ni and Cu.

25. The method of claim 1, wherein a portion of the carbon nanotubes product is impregnated again and used in the process of forming carbon nanotubes and hydrogen.

26. The methods of claim 1, wherein hydrogen is also collected as a product of the exposing step.
